(19) United States
(12) Patent Application Publication
(10) Pub. No.: US 2022/0013765 A1
(43) Pub. Date: Jan. 13, 2022

(54) GRAPHITIC CARBON NITRIDE MATERIALS AND METHODS OF MAKING AND USE THEREOF

(71) Applicant: NEW YORK UNIVERSITY, New York, NY (US)

(72) Inventors: Guoming Weng, Guangdong (CN); Hang Wang, Brooklyn, NY (US); André D. Taylor, Brooklyn, NY (US)

(21) Appl. No.: 17/371,613

(22) Filed: Jul. 9, 2021

Related U.S. Application Data
(60) Provisional application No. 63/050,221, filed on Jul. 10, 2020.

(51) Int. Cl. H01M 4/133; H01M 10/054; H01M 4/1393; C01B 21/06

(52) U.S. Cl. CPC H01M 4/133; H01M 10/054; H01M 2004/028; C01B 21/0605; H01M 4/1393

(57) ABSTRACT

A composition comprising a graphitic carbon nitride material and a conductive carbon material coating may be used in electrodes or in batteries such as sodium ion batteries. The composition may be prepared using a method comprising the steps of providing a nitrogenous compound; adding a carbonaceous material to the nitrogenous compound to form a slurry; drying the slurry to form a coated mixture; and carbonizing the coated mixture.

### CROSS-REFERENCE TO RELATED APPLICATIONS

The present application claims priority to U.S. Provisional Application Ser. No. 63/050,221, filed on Jul. 10, 2020, which is incorporated by reference herein in its entirety.

### STATEMENT REGARDING FEDERALLY SPONSORED RESEARCH OR DEVELOPMENT

This invention was made with government support under CBET-0954985, awarded by the National Science Foundation. The Government has certain rights in the invention.

### BACKGROUND OF THE INVENTION

Electric vehicles are one of the most promising ways of reducing carbon emissions from the transportation sector. Although the electric vehicle market is growing, the cost of lithium-ion batteries (LIBs) is one of the major hurdles standing in the way of widespread use of electric cars. To greatly reduce the cost of a battery and make it commercially viable, battery materials should be chosen to be low-cost, abundant, easy-processable and non-toxic (Vaalma, et al., Nat. Rev. Mater. 2018, 3, 18013.). Towards a long-life battery system, these materials should be able to undergo reversible intercalation with minimal volume changes during operation (Braga, et al., Energy Environ. Sci. 2017, 10, 331). There is keen interest in developing alternative rocking-chair batteries (Masse, et al., Sci. China Mater. 2015, 58, 715; Ryu, et al., ACS Nano 2016, 10, 3257), for example, sodium-ion batteries (NIBs) due to the abundance of sodium relative to lithium (Liu, et al., Proc. Natl. Acad. Sci. 2016, 113, 3735; Balogun, et al., Carbon 2016, 98, 162; Chevrier and Ceder, J. Electrochem. Soc. 2011, 158, A1011; Slater, et al. Adv. Funct. Mater. 2013, 23, 947). However, one of the biggest challenges facing NIBs is the negative electrode (Wang, et al., J. Mater. Chem. A 2018, 6, 6183). Although graphite electrodes are attractive for LIBs due to their low-cost (Mao, et al., J. Electrochem. Soc. 2018, 165, A1837), these materials are thermodynamically unstable with high Na content and therefore suffer from very low Na storage (<35 mAh/g) (Wen, et al. Nat. Comm. 2014, 5, 4033).

In contrast to recently reported carbon-based negative electrodes (e.g., hard carbon with intrinsically disordered microstructure (Li, et al., Chem. Commun. 2017, 53, 2610) and heteroatom-doped carbon (Fu, et al., Nanoscale 2014, 6, 1384), layered two-dimensional graphene-like graphitic carbon nitride (g-C₃N₄) nanosheet is an obvious candidate owing to its easy scalability (via simple polymerization or polycondensation (Adekoya, et al., Adv. Funct. Mater. 2018, 28, 1803972), low cost (Li, et al., Chem. Mater. 2018, 30, 4536), chemical stability in different environments (e.g., acid, base or organic solvent) (Yin, et al., Catal. Sci. Technol. 2015, 5, 5048) and potentially high rate capability (Li, et al., Chem. Commun. 2017, 53, 2610; Subramaniyam, et al., Electrochim. Acta 2017, 237, 69). Theoretical studies by pioneers (Adekoya, et al., Adv. Funct. Mater. 2018, 28, 1803972; Wu, et al., J Phys. Chem. C 2013, 117, 6055; Veith, et al., Chem. Mater. 2013, 25, 503; Pan, J. Phys. Chem. C 2014, 118, 9318; Hankel, et al., J. Phys. Chem. C 2015, 119, 21921) show that g-C₃N₄ has a high Li-storage capacity up to 524 mAh/g, which could indicate a similarly promising application with Na. However, g-C₃N₄ exhibits a poor electronic conductivity (Subramaniyam, et al., Electrochim. Acta 2017, 237, 69), low reversible Na-storage capacity (e.g., 10 mAh/g) and insufficient cyclability caused by the irreversible intercalation reaction. To improve its electronic conductivity and cyclability, g-C₃N₄ should be modified to deliver a high density of pyridinic terminal bonds and a low density of quaternary graphitic nitrogen species.

There is a need in the art for high-performance materials for sodium ion batteries. The present invention satisfies this unmet need.

### SUMMARY OF THE INVENTION

In one aspect, the present invention relates to a composition comprising a graphitic carbon nitride material and a conductive carbon material coating. In one embodiment, the graphitic carbon nitride material comprises graphitic carbon nitride. In one embodiment, the graphitic carbon nitride material is selected from the group consisting of a nanosheet, a nanoparticle, a nanowire, a nanorod, a quantum dot, and a 3D network. In one embodiment, the graphitic carbon nitride material is partially coated with the conductive carbon material. In one embodiment, the graphitic carbon nitride material is fully coated with the conductive carbon material. In one embodiment, the composition comprises multiple graphitic carbon nitride layers with the conductive carbon material therebetween.

In one embodiment, the conductive carbon material comprises at least one allotrope of carbon selected from the group consisting of graphene, graphene oxide, reduced graphene oxide, graphenylene, graphite, exfoliated graphite, AA′-graphite, Schwarzites, graphite oxide, carbon fiber, activated carbon, carbon nanotubes, buckminsterfullerenes amorphous carbon, glassy carbon, carbon aerogels, carbon foam, and Q-carbon. In one embodiment, the conductive carbon material comprises amorphous carbon. In one embodiment, the conductive carbon material further comprises at an additional element selected from the group consisting of hydrogen, boron, nitrogen, oxygen, silicon, phosphorous, sulfur, germanium, arsenic and selenium. In one embodiment, the conductive carbon material further comprises an alkali metal, an alkaline metal, or a transition metal.

The present invention also relates to an electrode comprising the composition and a conductive metal, to a battery comprising said electrode and a positive electrode, and to a sodium ion battery comprising the composition and a sodic positive electrode.

In another aspect, the present invention relates to A method of making a composition comprising a graphitic carbon nitride material and a conductive carbon material coating; the method comprising the steps of: providing a nitrogenous compound; adding a carbonaceous material to the nitrogenous compound to form a slurry; drying the slurry to form a coated mixture; and carbonizing the coated mixture. In one embodiment, the step of drying the slurry further comprises the step of grinding the slurry. In one embodiment, the step of carbonizing the coated mixture comprises the step of heating the coated mixture to a temperature of at least 500° C. in an inert atmosphere.

In one embodiment, the nitrogenous compound is selected from the group consisting of urea, thiourea, guanidine, cyanamide, dicyanamide, cyanuric acid, melamine, uric acid, and derivatives thereof. In one embodiment, the carbonaceous material is selected from the group consisting of asphalt, natural bitumen, refined bitumen, recycled bitumen, polymer-modified bitumen, rubber, styrene-butadiene polymers, recycled tires, petroleum pitches obtained from a cracking process, coal tar, recycled crumb rubber, petroleum oil, oil residue of paving grade, plastic residue from coal tar distillation, petroleum pitch, asphalt cements, cutback asphalts, kerogen, asphaltenes, petroleum jelly, and paraffins.

In one embodiment, at least one of the nitrogenous compound and the carbonaceous material further comprises a solvent. In one embodiment, the solvent is selected from the group consisting of methanol, ethanol, 1-pronanol, 2-propanol, n-butanol, 1-pentanol, t-butyl alcohol, carbon tetrachloride, chlorobenzene, ethyl acetate, acetone, dichloromethane, chloroform, benzene, toluene, ethylene glycol, pentane, hexane, petroleum ether, diethyl ether, acetic acid, acetonitrile, 1,2-dimethoxyethane, dimethylformamide, dimethyl sulfoxide, 1,4-dioxane, n-methyl-2-pyrrolidinone, nitromethane, pyridine, tetrahydrofuran, triethylamine, xylenes, or a combination thereof.

### BRIEF DESCRIPTION OF THE DRAWINGS

The following detailed description of preferred embodiments of the invention will be better understood when read in conjunction with the appended drawings. For the purpose of illustrating the invention, there are shown in the drawings embodiments which are presently preferred. It should be understood, however, that the invention is not limited to the precise arrangements and instrumentalities of the embodiments shown in the drawings.

FIG. 1 is a flowchart depicting an exemplary method of preparing a composition of the present invention.

FIG. 2 is a schematic illustration of an exemplary preparation of C/g-C₃N₄.

FIG. 3, comprising FIGS. 3A through 3E, depicts the characterization of nano-sized Na₂C₆O₆. FIG. 3A is a SEM image of the as-prepared Na₂C₆O₆. FIG. 3B is a SEM image of the as-prepared Na₂C₆O₆ with a closer zoom. FIG. 3C depicts the solubility of the as-prepared Na₂C₆O₆ in the tested electrolyte (i.e., 0.8 M NaClO₄ in EC:DEC). It is clearly seen that Na₂C₆O₆ cannot be dissolved into the tested solvents. FIG. 3D is a cyclic voltammogram of a Na₂C₆O₆ half cell with a scan window of 0.5-3.3 V. The inset is a photograph of the Na side after dissembling the cell. FIG. 3E is a cyclic voltammogram of a Na₂C₆O₆ half cell with a scan window of 0.5-3 V. The inset is a photograph of the Na side after dissembling the cell.

FIG. 4, comprising FIGS. 4A through 4E, provides characterization of the g-C₃N₄ nanosheet based on DFT calculations. FIG. 4A shows the structure of a bulk g-C₃N₄ nanosheet. FIG. 4B shows the structure of a buckled g-C₃N₄ nanosheet. FIG. 4C is a plot showing the relative adsorption energy for g-C₃N₄ sheet. FIG. 4D depicts the schematics of a Na diffusion pathway used in DFT calculations. FIG. 4E is a plot of the corresponding calculated energy profile of the pathway shown in FIG. 4D.

FIG. 5 is a plot showing the rate performance of Na half cells using C/g-C₃N₄ prepared from different recipes. Compared to the data shown in FIG. 16, the best ratio of urea to asphalt is 1:0.2.

FIG. 6 depicts the XRD spectra of g-C₃N₄ and C/g-C₃N₄. Insets are the photographs of g-C₃N₄ (bottom) and C/g-C₃N₄ powders (top).

FIG. 7 is a plot of the Raman spectra of C/g-C₃N₄, g-C₃N₄ and asphalt-derived carbon.

FIG. 8 depicts the XPS surface spectra of g-C₃N₄ and C/g-C₃N₄.

FIG. 9 depicts the high-resolution XPS spectra of the C is regions for g-C₃N₄ and C/g-C₃N₄.

FIG. 10 depicts the high-resolution XPS spectra of the N is regions for g-C₃N₄ and C/g-C₃N₄.

FIG. 11 is a SEM image of the as-prepared g-C₃N₄.

FIG. 12 is a SEM image of the as-prepared C/g-C₃N₄.

FIG. 13 is a TEM image of the as-prepared g-C₃N₄.

FIG. 14 is a TEM image of the as-prepared C/g-C₃N₄.

FIG. 15 is a cyclic voltammogram of Na half cells using g-C₃N₄ or C/g-C₃N₄ as working electrode and Na metal as counter electrode with a scan rate of 1 mV/s.

FIG. 16 is a plot of the rate capability of Na half cells using g-C₃N₄ or C/g-C₃N₄ as working electrode and Na metal as counter electrode.

FIG. 17 is a plot of the rate performance of Na half cells using asphalt-derived carbon as negative active material.

FIG. 18 is a plot of galvanostatic charge/discharge curves of C/g-C₃N₄ Na half cells at 0.4 A/g.

FIG. 19 is a plot of cycling performance of C/g-C₃N₄ Na half cells at 0.4 A/g.

FIG. 20 is a series of SEM images of C/g-C₃N₄ electrodes before and after the electrochemical test shown in FIG. 19.

FIG. 21 depicts an exemplary configuration of a C/g-C₃N₄Na full cell consisting of a positive electrode of Na₂C₆O₆ and a negative electrode of C/g-C₃N₄. Current and electrons flow during operation are also included.

FIG. 22 is a cyclic voltammogram of a C/g-C₃N₄ Na full cell at a scan rate of 1 mV/s.

FIG. 23 is a plot of rate performance of Na₂C₆O₆ Na half cells. The Na half cell with the as-prepared Na₂C₆O₆ achieved an electrochemical performance comparable to that reported in the literature.

FIG. 24 is a plot of cyclic performance of Na₂C₆O₆ Na half cells.

FIG. 25 is a plot of galvanostatic charge/discharge curves of C/g-C₃N₄ Na full cells at different current densities.

FIG. 26 is a plot of the cycling performance of a C/g-C₃N₄ Na full cell at 1 A/g.

FIG. 27 is a plot of specific charge/discharge curves of the Na₂C₆O₆/C/g-C₃N₄ Na full cell. This figure corresponds to FIG. 26.

### DETAILED DESCRIPTION

It is to be understood that the figures and descriptions of the present invention have been simplified to illustrate elements that are relevant for a clear understanding of the present invention, while eliminating, for the purpose of clarity, many other elements found in electrochemical materials. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

As used herein, each of the following terms has the meaning associated with it in this section. Unless defined otherwise, all technical and scientific terms used herein generally have the same meaning as commonly understood by one of ordinary skill in the art to which this invention belongs.

The articles “a” and “an” are used herein to refer to one or to more than one (i.e. to at least one) of the grammatical object of the article. By way of example, “an element” means one element or more than one element.

As used herein, the term “about” will be understood by persons of ordinary skill in the art and will vary to some extent depending on the context in which it is used. As used herein when referring to a measurable value such as an amount, a temporal duration, and the like, the term “about” is meant to encompass variations of 20% or ±10%, more preferably +5%, even more preferably ±1%, and still more preferably ±0.1% from the specified value, as such variations are appropriate to perform the disclosed methods.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

### DESCRIPTION

The present invention is based in part on the unexpected discovery that graphitic carbon nitride having a carbon coating displays superior properties as a negative electrode in a sodium ion battery (NIB).

### Compositions of the Invention

In one aspect, the present invention relates to a composition comprising a graphitic carbon nitride material and a conductive carbon material coating. In one embodiment, the composition is a nanocomposite.

In one embodiment, the graphitic carbon nitride material is a polymeric material which may comprise carbon and nitrogen atoms, but the material is not limited thereto. In one embodiment, the graphitic carbon nitride may further comprise additional elements, including but not limited to, hydrogen, boron, nitrogen, oxygen, silicon, phosphorous, sulfur, germanium, arsenic or selenium. In one embodiment, the graphitic carbon nitride may comprise at least one alkali metal, alkaline metal, or transition metal.

The graphitic carbon nitride material may comprise a compound having the molecular formula C₃N₄, but the stoichiometric ratio of carbon to nitrogen is not limited to 3:4. In one embodiment, the exact ratio of carbon to nitrogen may be above or below 3:4 depending on the method of synthesis and the precursors used. In one embodiment, the ratio of carbon to nitrogen in the carbon nitride material is between about 0.60 and 0.90. In one embodiment, the ratio of carbon to nitrogen is between about 0.64 and 0.88. In one embodiment, the ratio of carbon to nitrogen is between about 0.65 and 0.87.

In one embodiment, the graphitic carbon nitride material comprises at least one species of nitrogen. In one embodiment, the graphitic carbon nitride material comprises graphitic nitrogen. In one embodiment, the graphitic carbon nitride material comprises pyridine nitrogen. In one embodiment, the content of pyridine nitrogen is higher than the content of graphitic nitrogen.

In one embodiment, the graphitic carbon nitride material comprises a polymeric material having multiple units arranged in a two-dimensional structure. In one embodiment, the units comprise triamino-s-heptazine. In one embodiment, the graphitic carbon nitride comprises pores between adjacent triamino-s-heptazine units. In some embodiments, the graphitic carbon nitride has a nanomaterial structure. Exemplary nanomaterials include, but are not limited to, nanosheets, nanoparticles, nanowires, nanoplatelets, nanolaminas, nanoshells. nanocrystals, nanospheres, nanorods, nanotubes, nanocylinders, nanoboxes, nanostars, tetrapods, nanobelts, nanoflowers, quantum dots, 3D networks, and the like.

In one embodiment, the graphitic carbon nitride material comprises graphitic carbon nitride nanosheets. In one embodiment, the nanosheets comprise planar or nearly-planar graphitic carbon nitride. In one embodiment, the nanosheets comprise multiple layers of planar or nearly planar graphitic carbon nitride. In one embodiment, the thickness of the nanosheets measured from the top surface to the bottom surface of the planar material, is between about 0.1 μm and about 10 μm. In one embodiment, the thickness is between about 0.5 and 5 μm. In one embodiment, the thickness is between about 0.75 and 2.5 μm. In one embodiment, the thickness is about 1 μm. In one embodiment, the coating does not substantially change the thickness of the nanosheet.

In one embodiment, the graphitic carbon nitride material comprises multiple layers of carbon nitride. In one embodiment, each layer of carbon nitride is planar or nearly planar. In one embodiment, the graphitic carbon nitride material comprises a single layer of carbon nitride. In one embodiment, the graphitic carbon nitride comprises two-dimensional carbon nitride material. In one embodiment, the graphitic carbon nitride has a graphene-like structure. In one embodiment, the graphitic carbon nitride has an amorphous structure. In one embodiment, the graphitic carbon nitride has a porous structure.

In one embodiment, the carbon material comprises at least one carbon allotrope. Exemplary carbon allotropes include, but are not limited to, graphene, graphene oxide, reduced graphene oxide, graphenylene, graphite, exfoliated graphite, AA′-graphite, Schwarzites, graphite oxide, carbon fiber, activated carbon, carbon nanotubes, buckminsterfullerenes (C₆₀, C₇₀, C₅₄₀, and the like), amorphous carbon (informally called carbon black), glassy carbon (also called vitreous carbon), carbon aerogels, carbon foam, Q-carbon, and combinations thereof. In one embodiment, the carbon material comprises more than one carbon allotrope. In one embodiment, the carbon material comprises a complex mixture of carbon allotropes.

In one embodiment, the conductive carbon material further comprises additional non-carbon elements, including but not limited to hydrogen, boron, nitrogen, oxygen, silicon, phosphorous, sulfur, germanium, arsenic or selenium. In one embodiment, the conductive carbon material further comprises at least one alkali metal, alkaline metal, or transition metal.

In one embodiment, the conductive carbon material has an ordered structure. In one embodiment, the conductive carbon material has an amorphous structure. In one embodiment, the conductive carbon material has a turbostratic structure. In one embodiment, the conductive carbon material has regions of ordered structure, said ordered structure comprising one or more allotrope of carbon, and regions of amorphous structure.

In one embodiment, the conductive carbon material is disposed over the graphitic carbon nitride material. In one embodiment, the conductive carbon material fully coats the graphitic carbon nitride material. In one embodiment, the conductive carbon material partially coats the graphitic carbon nitride material. In one embodiment, the conductive carbon material coats one face of the graphitic carbon nitride material. In one embodiment, the conductive carbon material coats multiple faces of the graphitic carbon nitride material. In one embodiment, the conductive carbon material covers at least 5% of the surface of the graphitic carbon nitride material. some embodiments, the conductive carbon material covers at least 10%, 15%, 20%, 25%, 30%, 35%, 40%, 45%, 50%, 55%, 60%, 65%, 70%, 75%, 80%, 85%, 90%, 95%, or 100% of the surface area of the graphitic carbon nitride material. In one embodiment, the conductive carbon material covers 10%, 15%, 20%, 25%, 30%, 35%, 40%, 45%, 50%, 55%, 60%, 65%, 70%, 75%, 80%, 85%, 90%, 95%, or 100% of the surface area of the graphitic carbon nitride material.

In one embodiment, the composition comprises multiple graphitic carbon nitride layers with the conductive carbon material therebetween. In one embodiment, the composition comprises multiple layers of conductive carbon material graphitic carbon nitride material. In one embodiment, the conductive carbon material and graphitic carbon nitride materials alternate within the composition. In one embodiment, the multiple layers of conductive carbon material and graphitic carbon nitride material are interlayered such that the two materials alternate within the composition. In one embodiment, the interlayer stacking which may be common in carbon nitride is not present in the composition of the present invention.

In one embodiment, the graphitic carbon nitride binds the conductive carbon material via donor-acceptor interactions. In one embodiment, the conductive carbon material is at least partially confined to interlayer gaps in the graphitic carbon nitride material. In one embodiment, the conductive carbon material is fully confined to interlayer gaps in the graphitic carbon nitride material.

In one embodiment, the ratio of graphitic carbon nitride material to conductive carbon material is between about 5:95 and 25:75. In one embodiment, the ratio is between about 10:90 and 20:80. In one embodiment, the ratio is about 5:95, 10:90, 15:85, 20:80, or 25:75.

In one embodiment, the composition further comprises a binder. Exemplary binders include alginic acid, a carbomer, carboxymethyl cellulose, carrageenan, cellulose acetate phthalate, chitosan, ethyl cellulose, guar gum, hydroxyethyl cellulose, hydroxyethylmethyl cellulose, hydroxypropyl cellulose, hydroxypropyl methyl cellulose, methyl cellulose, microcrystalline cellulose, poloxamer, polyethylene oxide, polymethacrylates, povidone, a saccharide, starch, partially pregelatinized starch, and the like, or a combination thereof. In one embodiment, the binder comprises carboxymethyl cellulose.

In one aspect, the present invention relates to electrodes comprising a composition described herein. In one embodiment, the electrode comprises a composition described herein and a conductive metal. In one embodiment, the electrode comprising the composition is a negative electrode. In one embodiment, the negative electrode further comprises sodium ions. In one embodiment, the negative electrode further comprises lithium ions. In one embodiment, the negative electrode further comprises sodium metal. In one embodiment, the negative electrode further comprises lithium metal.

The present invention also relates to a battery comprising an electrode described herein and a positive electrode. There is no particular limit on the composition of the positive electrode. In one embodiment, the positive electrode is a sodic positive electrode. In one embodiment, the positive electrode comprises a sodium salt. Exemplary sodium salts include sodium terephthalate, sodium-iron hexacyanoferrate, sodium carboxylates, sodium phthalimide, NaFeSO₄F and NaMnO₂. In one embodiment, a combination of two or more sodium salts may be used. In one embodiment, the positive electrode comprises sodium rhodizonate. In one embodiment, the positive electrode comprises a sodium salt having the formula Na₂C₆O₆. In one embodiment, the sodium salt is recrystallized. In one embodiment, the particle size of the sodium salt is about 200 nm.

In one embodiment, the battery further comprises an electrolyte. There is no particular limit on the electrolyte. In one embodiment, the electrolyte comprises a sodium salt. Examples of the sodium salt electrolyte include NaClO₄, NaPF₆, NaAsF₆, NaSbF₆, NaBF₄, NaCF₃SO₃, NaN(SO₂CF₃)₂, lower aliphatic carboxylic sodium salts, and NaAlCl₄, two or more of which may be used.

In one embodiment, the electrolyte comprises one or more solvents. In one embodiment, the solvent in nonaqueous. In one embodiment, the solvent is aprotic. In one embodiment, the solvent is an organic solvent. Exemplary organic solvents include, but are not limited to, carbonates such as propylene carbonate, ethylene carbonate, dimethyl carbonate, diethyl carbonate, diethylene carbonate, ethyl methyl carbonate, isopropyl methyl carbonate, vinylene carbonate, 4-trifluoromethyl-1,3-dioxolane-2-one, and 1,2-di(methoxycarbonyloxy)ethane; ethers such as 1,2-dimethoxyethane, 1,3-dimethoxypropane, pentafluoropropyl methyl ether, 2,2,3,3-tetrafluoropropyl difluoromethyl ether, tetrahydrofuran, and 2-methyltetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, and 1,3-propane sultone; or those obtained by introducing additional fluorine substituents into the above-described organic solvents. In one embodiment, a combination of two or more organic solvents is considered. In one embodiment, the concentration of the sodium salt in the solvent is greater than about 0.1 M. In one embodiment, the concentration of the sodium salt in the solvent is greater than about 0.2 M. In one embodiment, the concentration of the sodium salt in the solvent is greater than about 0.3 M. In one embodiment, the concentration of the sodium salt in the solvent is greater than about 0.4 M. In one embodiment, the concentration of the sodium salt in the solvent is greater than about 0.5 M. In one embodiment, the concentration of the sodium salt in the solvent is greater than about 0.6 M. In one embodiment, the concentration of the sodium salt in the solvent is greater than about 0.7 M. In one embodiment, the concentration of the sodium salt in the solvent is greater than about 0.8 M. In one embodiment, the concentration of the sodium salt in the solvent is greater than about 0.9 M. In one embodiment, the concentration of the sodium salt in the solvent is greater than about 1.0 M.

### Methods of Making

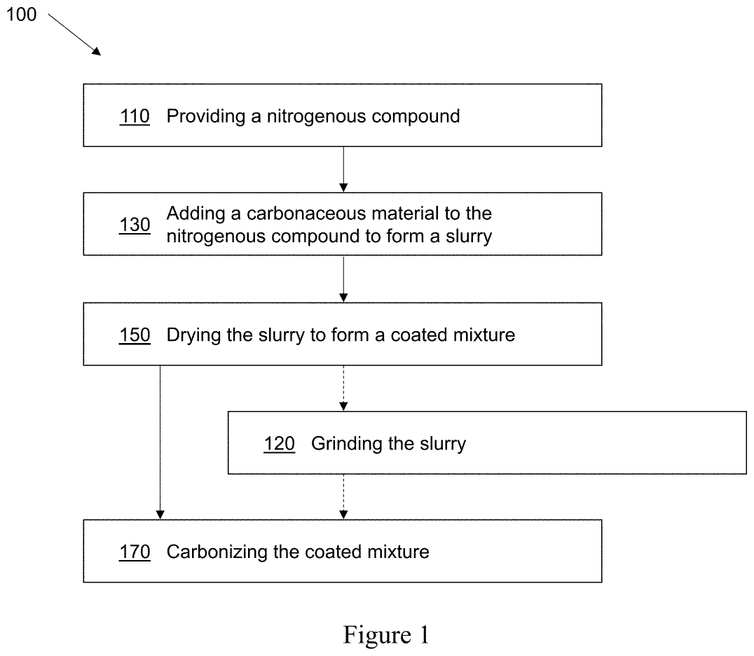

In one aspect, the present invention relates to a method of making a composition comprising a graphitic carbon nitride material and a conductive carbon material coating. Exemplary method 100 is presented in FIG. 1. In step 110, a nitrogenous compound is provided. In step 130, a carbonaceous material is added to the nitrogenous compound to form a slurry. In step 150, the slurry is dried to form a coated mixture. In step 170, the coated mixture is carbonized. In one embodiment, step 150 further comprises step 160, in which the slurry is ground.

The nitrogenous compound may be any compound comprising nitrogen. In one embodiment, the compound comprises an organic compound comprising nitrogen. In one embodiment, the compound comprises an inorganic compound comprising nitrogen. In one embodiment, the nitrogenous compound comprises at least one carbonyl, carboxylic acid, imine, iminium, amide, urea, guanidine, or similar carbonyl or carbonyl derivatives. Exemplary nitrogenous compounds include, but are not limited to, urea, thiourea, guanidine, cyanamide, dicyanamide, cyanuric acid, melamine, uric acid, and derivatives thereof.

The carbonaceous material may be any material comprising carbon. In some embodiments, the carbonaceous material comprises a recycled material or a byproduct material from a refinery process. Exemplary carbonaceous materials include, but are not limited to, asphalt, natural bitumen, refined bitumen, recycled bitumen, polymer-modified bitumen, rubber, styrene-butadiene polymers, recycled tires, petroleum pitches obtained from a cracking process, coal tar, recycled crumb rubber, petroleum oil, oil residue of paving grade, plastic residue from coal tar distillation, petroleum pitch, asphalt cements, cutback asphalts, kerogen, asphaltenes, petroleum jelly, and paraffins.

In one embodiment, the carbonaceous material comprises a hydrocarbon recovered from tar sands and/or oil shales. Exemplary hydrocarbons include, but are not limited to, bitumen, kerogen, asphaltenes, paraffins, alkanes, aromatics, olefins, naphthalenes, and xylenes.

In one embodiment, the bitumen is derived from foreign or domestic crude oil. Suitable bitumen types include, but are not limited to, the following: bitumen, natural asphalt, petroleum oil, oil residue of paving grade, plastic residue from coal tar distillation, petroleum pitch, asphalt cements, and cutback asphalts (i.e., asphalt diluted with hydrocarbon solvents such as kerosene or diesel oil).

In one embodiment, the carbonaceous material comprises a polymer-modified bitumen. In one embodiment, the polymer-modified bitumen is modified with a polymer such as, but not limited to, natural rubbers, synthetic rubbers, plastomers, thermoplastic resins, thermosetting resins, elastomers, and combinations thereof. Exemplary polymers include styrene-butadiene-styrene (SBS), styrene-butadiene-rubber (SBR), polyisoprene, polybutylene, butadiene-styrene rubber, vinyl polymer, ethylene vinyl acetate, ethylene vinyl acetate derivative, and the like.

In one embodiment, the mass ratio of nitrogenous compound to carbonaceous material is at least 1.0:0.1. In one embodiment, the mass ratio of nitrogenous compound to carbonaceous material is about 1.0:0.1. In one embodiment, the mass ratio of nitrogenous compound to carbonaceous material is about 1.0:0.2. In one embodiment, the mass ratio of nitrogenous compound to carbonaceous material is about 1.0:0.3. In one embodiment, the mass ratio of nitrogenous compound to carbonaceous material is about 1.0:0.4. In one embodiment, the mass ratio of nitrogenous compound to carbonaceous material is about 1.0:0.5. In one embodiment, the mass ratio of nitrogenous compound to carbonaceous material is about 1.0:0.6. In one embodiment, the mass ratio of nitrogenous compound to carbonaceous material is about 1.0:0.7. In one embodiment, the mass ratio of nitrogenous compound to carbonaceous material is about 1.0:0.8. In one embodiment, the mass ratio of nitrogenous compound to carbonaceous material is about 1.0:0.9. In one embodiment, the mass ratio of nitrogenous compound to carbonaceous material is less than 1.0:1.0.

In one embodiment, the nitrogenous compound further comprises a solvent. In one embodiment, the carbonaceous material further comprises a solvent. In one embodiment, both the nitrogenous compound and the carbonaceous material comprise a solvent. In one embodiment, the solvent for the nitrogenous compound and the carbonaceous material may be the same or different. In one embodiment, the solvent is selected so as to solvate the nitrogenous compound or the nitrogenous compound. In one embodiment, the nitrogenous compound and/or the carbonaceous material is soluble in the solvent. In one embodiment, the nitrogenous compound and/or the carbonaceous material is insoluble in the solvent. In one embodiment, the nitrogenous compound and/or the carbonaceous material is sparingly soluble in the solvent. In one embodiment, the nitrogenous compound and/or the carbonaceous material is nonreactive with the solvent. In one embodiment, the nitrogenous compound and/or the carbonaceous material is reactive with the solvent. Exemplary solvents include, but are not limited to, water, methanol, ethanol, 1-pronanol, 2-propanol, n-butanol, 1-pentanol, t-butyl alcohol, carbon tetrachloride, chlorobenzene, ethyl acetate, acetone, dichloromethane, chloroform, benzene, toluene, ethylene glycol, pentane, hexane, petroleum ether, diethyl ether, acetic acid, acetonitrile, 1,2-dimethoxyethane, dimethylformamide, dimethyl sulfoxide, 1,4-dioxane, n-methyl-2-pyrrolidinone, nitromethane, pyridine, tetrahydrofuran, triethylamine, xylenes, or combinations thereof.

In one embodiment, the step of carbonizing the coated mixture (step 170) comprises the step of heating the coated mixture to a temperature of at least 500° C. In one embodiment, the coated mixture is heated to a temperature of 500° C. In one embodiment, the coated mixture is heated to a temperature of 525° C. In one embodiment, the coated mixture is heated to a temperature of 550° C. In one embodiment, the coated mixture is heated to a temperature of 575° C. In one embodiment, the coated mixture is heated to a temperature of 600° C. In one embodiment, the coated mixture is heated to a temperature less than 700° C.

In one embodiment, the coated mixture is heated in an inert atmosphere. In one embodiment, the coated mixture is heated in an N₂ atmosphere. In one embodiment, the coated mixture is heated under low pressure. In one embodiment, the coated mixture is heated under vacuum. In one embodiment, the coated mixture is heated under a pressure greater than atmospheric pressure. In one embodiment, the coated mixture is heated at high pressure.

In one embodiment, the coated mixture is heated for at least 1 hour. In one embodiment, the coated mixture is heated for at least 2 hours. In one embodiment, the heated mixture is heated for at least 3 hours. In one embodiment, the heated mixture is heated for less than 4 hours.

In one embodiment, the coated mixture is heated gradually. In one embodiment, the coated mixture is slowly warmed to the desired temperature at a rate of 1, 2, 3, 4, 5, 6, 7, 8, 9, 10, 15, 20, 30, 40, or 50° C./min. In one embodiment, the coated mixture is immediately placed in an environment pre-warmed to the desired temperature.

### EXPERIMENTAL EXAMPLES

The invention is now described with reference to the following Examples. These Examples are provided for the purpose of illustration only, and the invention is not limited to these Examples, but rather encompasses all variations that are evident as a result of the teachings provided herein.

### Example 1: Preparation and Testing of Carbon-Coated Graphitic Carbon Nitride

Two-dimensional graphitic carbon nitride (g-C₃N₄) nanosheet is a promising negative electrode candidate for sodium-ion batteries (NIBs) owing to its easy scalability, low cost, chemical stability and potentially high rate capability. However, intrinsic g-C₃N₄ exhibits poor electronic conductivity, low reversible Na-storage capacity and insufficient cyclability. Density functional theory calculations suggest that this is due to a large Na⁺ ion diffusion barrier in the innate g-C₃N₄ nanosheet. As described herein, the strategic application of a carbon coating onto g-C₃N₄ to yield C/g-C₃N₄ nanocomposites improved Na-storage capacity (about 2 times higher, up to 254 mAh/g), rate capability and cyclability. A C/g-C₃N₄ sodium-ion full cell (in which sodium rhodizonate dibasic is used as the positive electrode) demonstrates high Coulombic efficiency (˜99.8%) and a negligible capacity fading rate over 12,000 cycles at 1 A/g. The design of the C/g-C₃N₄ negative electrode material offers effective strategies to develop low-cost and long-life NIBs.

### Materials and Methods

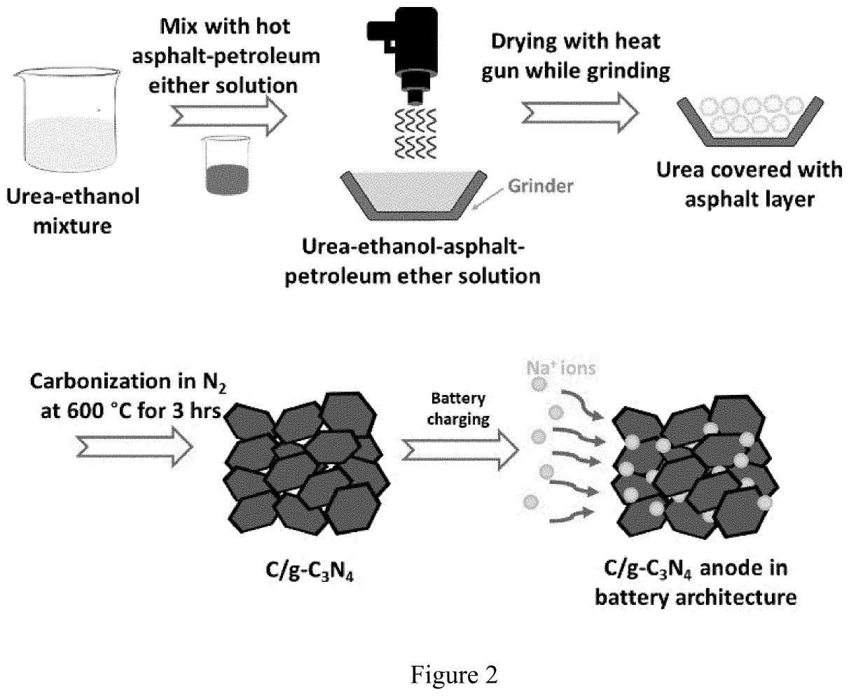

Preparation of C/g-C₃N₄. The synthesis procedure of C/g-C₃N₄ is illustrated in FIG. 2 and described as follows: (i) 1 g of urea (CH₄N₂O, 99.5%, Sigma Aldrich) was dissolved in 20 mL of absolute ethanol at 70° C.; (ii) the solution was transferred to a mortar and dried with a heat gun with further grinding. (iii) 0.6 g of asphalt (i.e. styrene-butadiene-styrene triblock copolymer modified asphalt and provided by GAF, USA) was first dissolved in 20 mL of petroleum ether (boiling point: 60-80° C., Sigma Aldrich) at 100° C. for 15 min with magnetic stirring; (iv) the hot asphalt-petroleum ether solution was then mixed with 1 g of urea precursor ground in the mortar and dried with a heat gun with further grinding; (v) the obtained urea-asphalt precursor was then carbonized in a furnace (OTF-1200X, MTI) at 600° C. (heating rate is 1° C./min) in N₂ for 3 hours to yield C/g-C₃N₄. The as-prepared bulk g-C₃N₄ sheet was prepared utilizing the same procedure except for the addition of the asphalt. Similarly, asphalt-derived carbon was prepared by the same method without adding urea precursor.

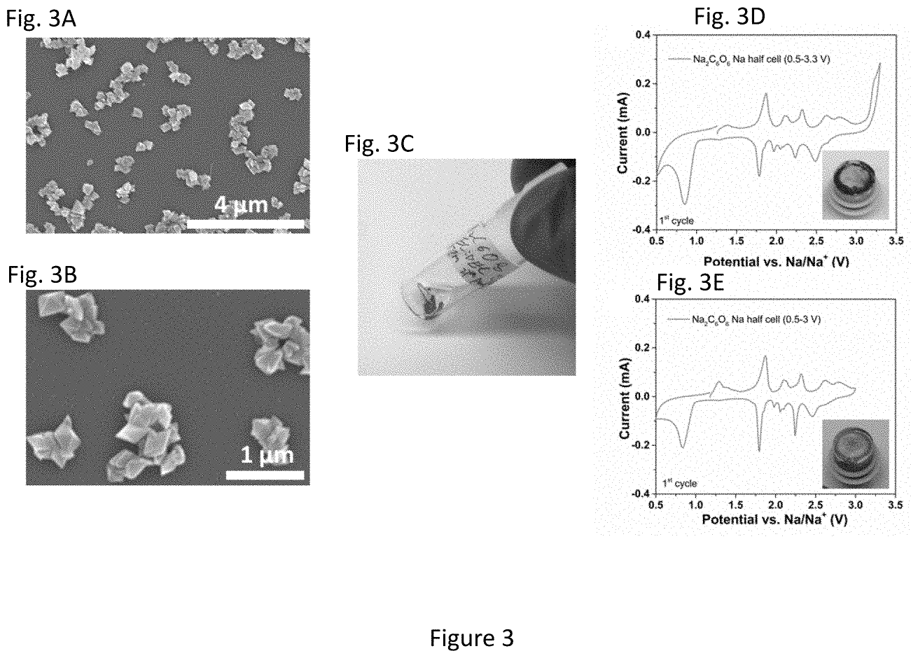

Recrystallization of Na₂C₆O₆. To reduce the particle size of the commercial Na₂C₆O₆, a modified procedure was used (Lee, et al., Nature Energy 2017, 2, 861) and described as follows. (i) 0.5 g of Na₂C₆O₆ powder (97%, Sigma Aldrich) was dissolved in 150 mL of DI H₂O at 80° C. for 30 mins. (ii) the above hot solution was quickly poured to 1250 mL of absolute ethanol with magnetic stirring for 5 mins. (iii) The precipitates were then collected by vacuum filtration through a 0.22 μm Milipore filter paper and dried in a vacuum oven at 70° C. for 1 hour. The particle size of the as-prepared Na₂C₆O₆ is about 200 nm (FIG. 3).

Characterization. X-ray diffraction (XRD) was conducted with a Bruker D8 Focus X-ray diffractometer. X-ray photoelectron spectroscopy (XPS) was conducted with a PHI VersaProbe II Scanning XPS Microprobe. All spectra were calibrated with respect to the C is peak resulting from the adventitious hydrocarbon at the energy of 284.8 eV. Raman spectra were recorded on a LabRAM HR Evolution Raman spectrometer (HORIBA Scientific, Japan) with a 532 nm laser. Scanning electron microscope (SEM) images were obtained using a Hitachi SU-70 SEM. Transmission electron microscopy (TEM) was performed with a FEI Tecnai Osiris 200 kV TEM.

Assembly and electrochemical test of C/g-C₃N₄ Na half cells. The working electrodes were prepared by mixing an active material (C/g-C₃N₄ or g-C₃N₄ or other control systems) with a carbon black conducting agent (Super P, Timcal) and a carboxymethyl cellulose binder (average Mw ˜90,000, Sigma Aldrich) with a weight ratio of about 50:37.5:12.5 in DI-H₂O. Then the prepared slurry was casted on a copper foil and was dried at 70° C. in a vacuum oven for about 12 hrs to remove the residual solvent. The electrodes were punched into circular discs with a diameter of 16 mm (˜2 cm²) and assembled into Swagelok-type cells. A piece of Celgard membrane (towards testing electrode) and a cellulose paper (towards Na metal) were used as the separator to alleviate the formation of Na dendrites (Weng, et al., Energy & Environmental Science 2017, 10, 735). The electrolyte was 180 μL of 0.8 M sodium perchlorate (NaClO₄, ≥99%, Sigma Aldrich) in the binary solvents of ethylene carbonate and diethylene carbonate (1:1 v:v) for each cell. Typically, the mass loading of the active material was in the range of about 0.3 to 0.4 mg/cm². The cells were tested with a Biologic VMP3 at room temperature. The CV analysis was carried out at 1 mV/s between 0.01 V and 2.0 V. Charge and discharge measurements were carried out between 0.01 and 2 V at different applied currents.

Assembly and electrochemical test of Na₂C₆O₆ Na half cells. The working electrodes were prepared by mixing an active material (i.e., nano-sized Na₂C₆O₆) with a carbon black conducting agent (Super P) and a polytetrafluoroethylene binder (60 wt % dispersion in H₂O) with a weight ratio of about 50:37.5:12.5 in N-Methyl-2-pyrrolidone (NMP). Then the prepared slurry was pasted on a stainless steel mesh and was dried at 100° C. in a vacuum oven for about 12 hours to remove the residual solvent. The electrodes (geometric area is about ˜ 2 cm²) were assembled into Swagelok-type cells. Same separators and supporting electrolytes as C/g-C₃N₄ Na half cells were used for these Na₂C₆O₆ Na half cells. Typically, the mass loading of the active material was in the range of about 0.4 to 0.7 mg/cm². The CV analysis was carried out at 0.1 mV/s between 0.5 and 3.3 V. Charge and discharge measurements were carried out between 1.0 and 2.8 V at different applied currents.

Assembly and electrochemical test of C/g-C₃N₄ Na full cells. Before the full-cell assembly, both positive (i.e., Na₂C₆O₆) and negative (i.e., C/g-C₃N₄) electrodes were first activated by a 3-cycle galvanostatic charge/discharge test at 0.1 A/g in individual half-cell systems (specific steps: initial discharge→1^{st} charge/discharge→2^{nd} charge/discharge→3^{rd} charge/discharge. In this case, C/g-C₃N₄ is fully sodiated after activation.). After activation, the Na₂C₆O₆ Na half-cell was galvanostatically charged up back to 2.8 V at 0.1 A/g and a constant voltage charging method (i.e., 2.8 V) was applied for 9 hours to maintain the desodiation. Then the C/g-C₃N₄ Na half-cell was dissembled, the used cellulose paper was replaced with a new one, and the Na side of the C/g-C₃N₄ Na half-cell was replaced by the activated Na₂C₆O₆ electrode. After that, 60 μL of the NaClO₄-based nonaqueous electrolyte was added to wet the cellulose paper and the Swagelok-type cell was sealed for battery testing. Here, the negative side was designed to be the capacity-limit side to characterize the performance of C/g-C₃N₄ in a full cell device. The cut-off voltage window for electrochemical measurements of the full cells was between 0.01 and 3 V. In this work, all specific values are based on the total mass of negative active materials (include asphalt-derived carbon and g-C₃N₄).

Computational methodology: First-principles calculations were carried out using density functional theory (DFT) and the all-electron projected augmented wave (PAW) method as implemented in the Vienna ab initio simulation package (VASP). For the exchange-correlation energy, the Perdue-Burke-Ernzerhof (PBE) version of the generalized gradient approximation (GGA) was used. The van der Waals interactions were added to the standard DFT description by Grimme's D2 scheme (Grimme, J. Comput. Chem. 2006, 27, 1787). A plane-wave cutoff energy of 520 eV was sufficient to ensure convergence of the total energies to 1 meV per primitive cell. The underlying structural optimizations were performed using the conjugate gradient method, and the convergence criterion was set to 10⁵ eV/cell in energy and 0.01 eV/in force. The vacuum separation between two nanosheets was set to 20 Å to avoid any interaction due to the use of periodic boundary conditions. Metal adsorptions were studied on a 3×3×1 C₃N₄ nanosheet with a Brillouin zone (BZ) sampling of 2×2×1 Monkhorst-Pack k-mesh, respectively. The adsorption energy of Na atom was calculated with

E_{ads}=(E(Naₙ@C₃N₄−E(C₃N₄)−C₃N₄)

where E(Nan@C₃N₄ is the total energy of a sodiated C₃N₄ sheet, E(C₃N₄) denotes the total energy of pristine C₃Nₛ sheet, C₃N₄ is the total energy of bcc Na, and n presents the number of adsorbed Na adatoms. In this scheme, the lower the adsorption energy, the stronger the binding between Na and C₃Nₛ sheet. The Na capacity was estimated from

C=nF/(M_{C}_{₃}_{N}_{ₛ}+nM_{Na})

where n is the number of adsorbed Na adatom, F is the Faraday constant (26801 mAh/mol), M_{C}_{₃}_{N}_{ₛ} is the mole weight of C₃Nₛ sheet, and M_{Na} is the mole weight of Na adatom. Note, the weight of the adsorbed metal adatom is not considered for most of the calculated capacities presented in literatures. The climbing image nudged elastic band method (CI-NEB) implemented in VASP was used to determine the energy barriers and minimum energy paths of surface reactions and metal diffusion. The NEB path was first constructed by linear interpolation of the atomic coordinates and then relaxed until the forces on all atoms were <0.05 eV/A. Five images were simulated between initial and final states.

### The Results of the Experiments Will Now be Discussed

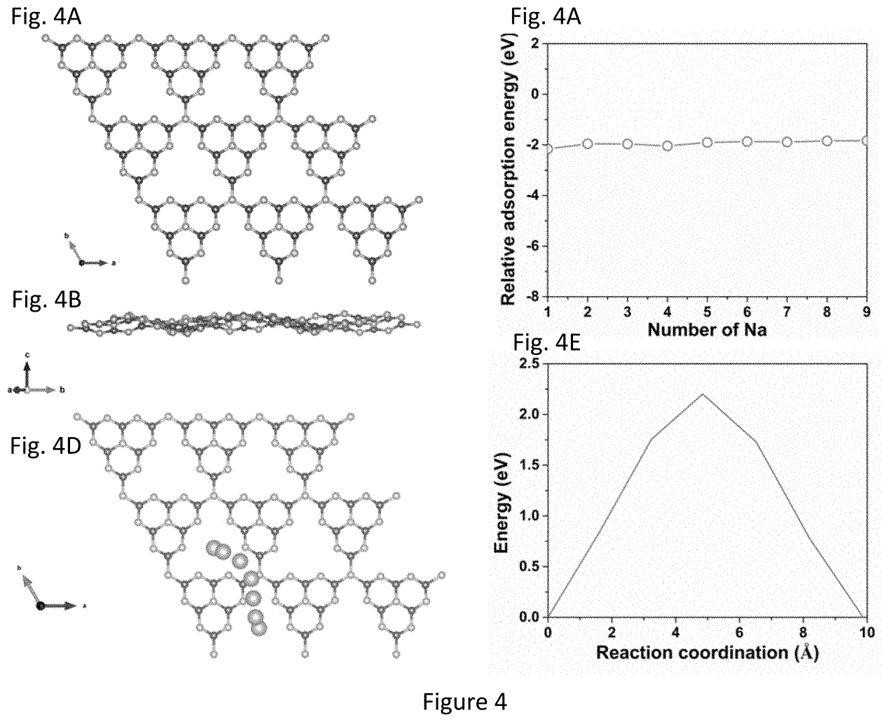

DFT calculations demonstrate a rather large Na diffusion barrier of about 2.2 eV in a g-C₃N₄ sheet with a path from one adsorption site to another (FIG. 4). To accelerate the ion diffusion inside the active matrix and improve its electronic conductivity, it was examined whether applying a conductive carbon layer onto the g-C₃N₄ sheet would lower the Na⁺ ion diffusion barrier and could be a feasible strategy for a high performance anode (Ding, et al., Catal. Sci. Technol. 2018, 8, 3484; Chen, et al., ACS Nano 2016, 10, 3665; Weng, et al., J. Mater. Chem. A 2017, 5, 11764; Li, et al., Angew. Chem. Int. Ed. 2012, 51, 9689).

DFT calculations predicted that buckled g-C₃N₄ nanosheet is more stable (ΔE=−0.27 eV/f.u. and ΔE=−0.039 eV/atom) than its flat counterpart (FIG. 4A and FIG. 4B). The relative adsorption energy of the Na ion in complete pores of bulk g-C₃N₄ nanosheet is estimated to be about 2 eV (FIG. 4C). Moreover, the adsorption energy of Na does not change much as the concentration is increased, suggesting the interaction between adsorbed Na atoms is very weak. The total theoretical Na-storage capacity obtained by DFT is 233 mAh/g for g-C₃N₄ nanosheet. Since the rate performance is mainly determined by the Na-ion mobility, the diffusion barrier of Na ion in a g-C₃N₄ sheet was calculated using a path from one adsorption site to another, as depicted in FIG. 4D. A rather large barrier of 2.2 eV is found, which means Na diffuses slowly on g-C₃N₄ sheet along this studied diffusion path (FIG. 4E).

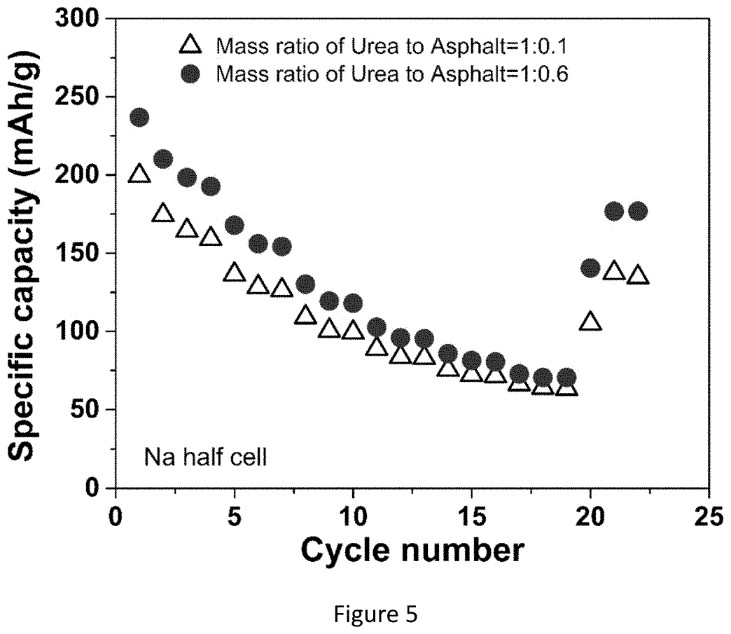

To prepare a carbon-coated g-C₃N₄, a one-pot heating of a mixture of urea and asphalt under N₂ atmosphere is used (FIG. 2). In a typical formation process, the thermal condensation of urea creates a layered carbon nitride template, which binds the as-formed aromatic carbon intermediates to its surface by means of donor-acceptor interactions (Li, et al., Angew. Chem. Int. Ed. 2012, 51, 9689) and finally confines their condensation in a cooperative process to the interlayer gaps of g-C₃N₄ at 600° C. Due to the appreciable flow behavior of the melted asphalt at high temperature, good adhesion between the two phases (i.e., urea and asphalt) can be achieved (Patel and Sharma, Res. J. Material Sci. 2017, 5, 1). This carbon coating significantly improves the electronic conductivity of g-C₃N₄ (Weng, et al., J. Mater. Chem. A 2017, 5, 11764) and enhances the ion diffusion between the adsorption sites. The mass ratio of urea to asphalt (or precursors) can be improved with a ratio of 1:0.2 in terms of electrochemical performance (FIG. 5).

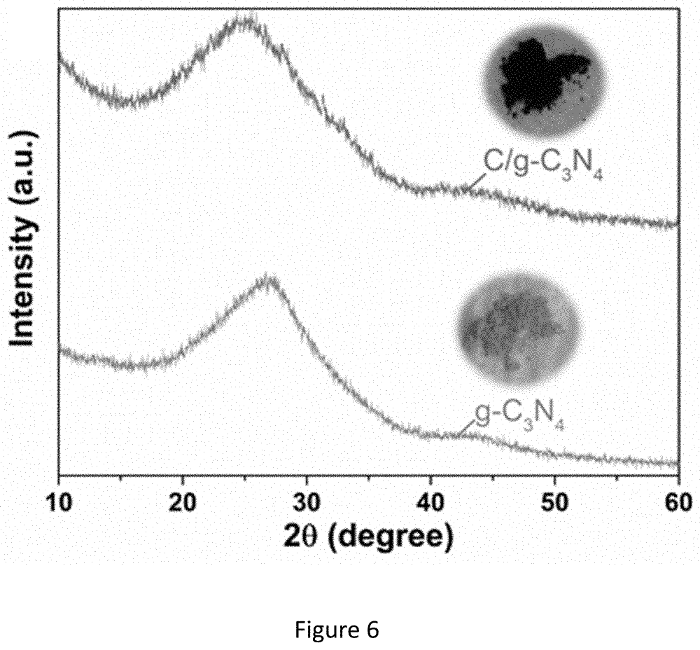

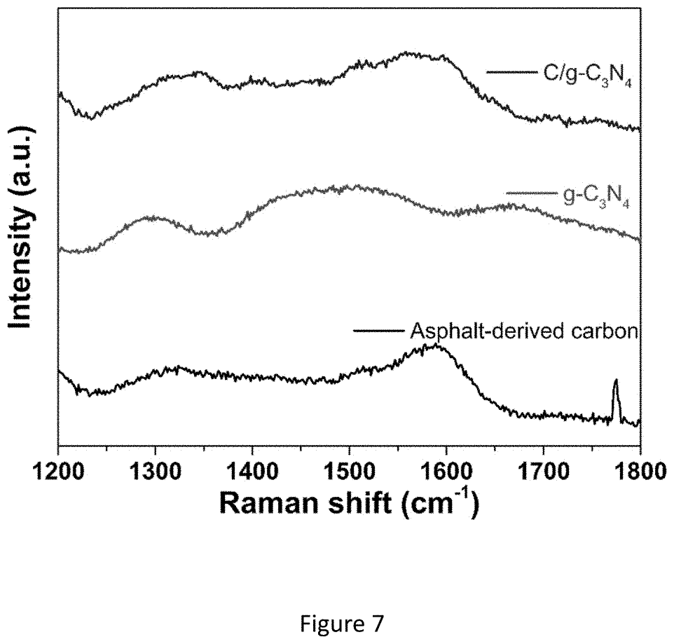

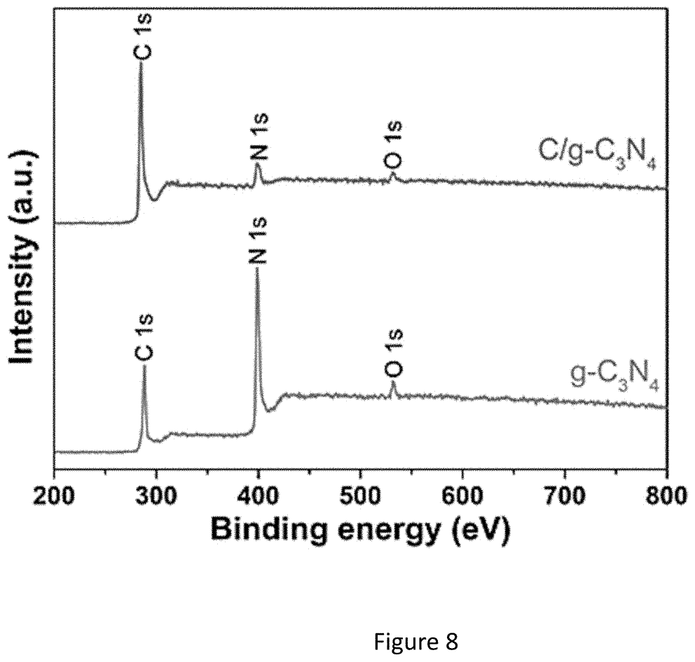

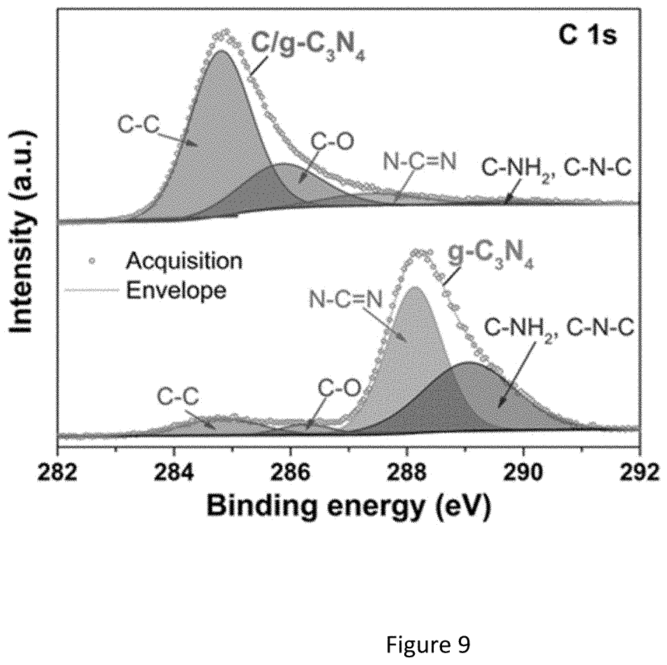

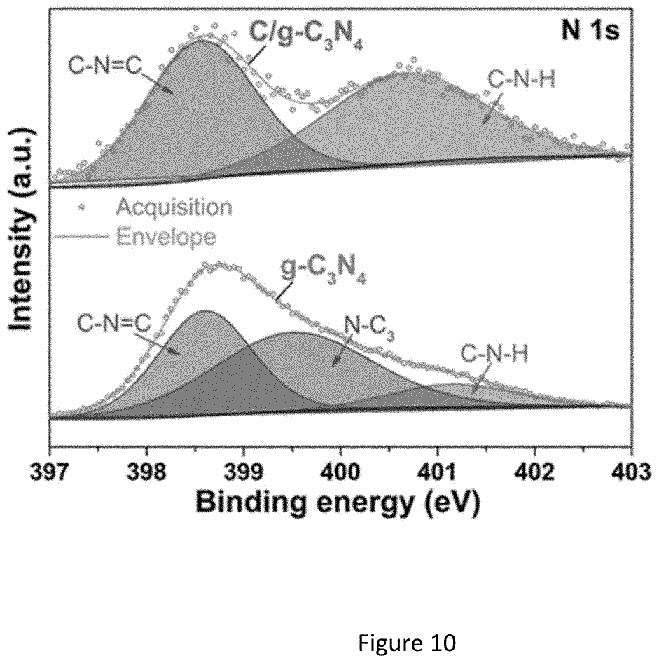

To understand the crystalline nature of the as-prepared materials, X-ray diffraction (XRD) spectroscopy results are shown in FIG. 6. The g-C₃N₄ control system shows a typical peak at about 270 (d-spacing=0.331 nm) which can be assigned to the interlayer-stacking of aromatic groups (Adekoya, et al., Adv. Funct. Mater. 2018, 28, 1803972). The other characteristic peak of g-C₃N₄ at about 130 (derived from the in-plane ordering of tri-s-triazine motifs) is absent or weak, which could be attributed to the destroyed stacking structure with decreased planar size of the layers (Fang, et al., ACS Sustainable Chem. Eng. 2017, 5, 2039). Similarly, C/g-C₃N₄ shows a broader peak for the stacking of aromatic groups, but it shifts to about 25° (d-spacing=0.358 nm). This indicates the coexistence of g-C₃N₄ and turbostratic carbon (Weng, et al., J. Mater. Chem. A 2017, 5, 11764), which could introduce a unique interlayer-stacking structure. Compared to the counterparts, the Raman spectrum of C/g-C₃N₄ shows the D peak (at about 1340 cm⁻¹) shifts toward higher wavenumbers (or blue shift), suggesting π-πstacking interactions between turbostratic carbon and electron-withdrawing g-C₃N₄ nanosheets (FIG. 7) (Han, et al., Adv. Energy Mater. 2018, 8, 1702992). X-ray photoelectron spectroscopy (XPS) measurements demonstrate the chemical compositions of the as-prepared materials. Both spectra (i.e., g-C₃N₄ and C/g-C₃N₄) consist of the following peaks located at about 285, 400 and 532 eV, and can be assigned to C Is, N is and O is (FIG. 8). The trace amount of oxygen could be attributed to the precursor (i.e., urea) and/or the solvent (i.e., ethanol) used during synthesis (Adekoya, et al., Adv. Funct. Mater. 2018, 28, 1803972). By integrating the peak area, C/g-C₃N₄ shows about 6.5 times less nitrogen content than that of g-C₃N₄. The practical nitrogen content could be higher than measured, because carbon layers largely cover g-C₃N₄ nanosheets (as evidenced by microscopy in the latter section). High-resolution XPS spectra of the C is and N is regions for both g-C₃N₄ and C/g-C₃N₄ are presented in FIG. 9 and FIG. 10. Four peaks centered at binding energies of 284.8, 286.2, 288.1 and 289.0 eV are obtained after deconvolution of the C is spectrum. The four peaks are attributed to the adventitious sp² C—C carbon species, sp³ hybridized carbon atoms in C—O, sp² hybridized carbon atoms in N—C—N, and those attached through the —NH₂ group, respectively (Adekoya, et al., Adv. Funct. Mater. 2018, 28, 1803972; Zhang, et al., J. Mater. Chem. A 2015, 3, 3281; Qiao, et al., Sens. Actuators B Chem. 2015, 216, 418). In line with the surface chemistries, less nitrogen-related bonding is observed for C/g-C₃N₄. The N is spectrum of g-C₃N₄ is deconvoluted into three peaks at 398.6, 399.5 and 401.1 eV (FIG. 9). These three peaks are assigned to sp²-hybridized nitrogen (pyridine-N) in triazine rings (C—N═C), tertiary nitrogen bonded to carbon atoms (pyrrolic-N) in the form of N—C₃ and graphitic-N in the form of C—N—H, respectively (Ding, et al., Catal. Sci. Technol. 2018, 8, 3484; Chen, et al., ACS Nano 2016, 10, 3665; Weng, et al., J. Mater. Chem. A 2017, 5, 11764; Luo, et al., J. Mater. Res. 2018, 33, 1268). For the N is spectrum of C/g-C₃N₄, only two peaks can be resolved, i.e., pyridine-N and graphitic-N (FIG. 10). Interestingly, the content of pyridine-N is slightly higher than graphitic-N, which might lead to improved Li/Na storage.

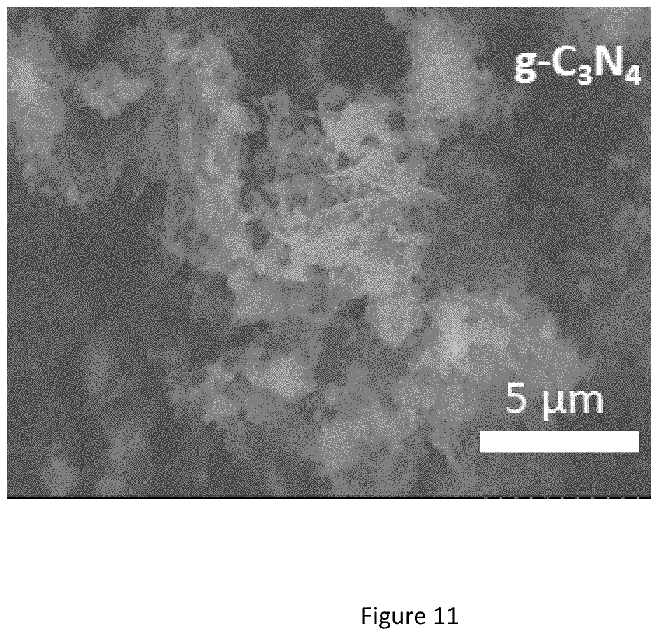

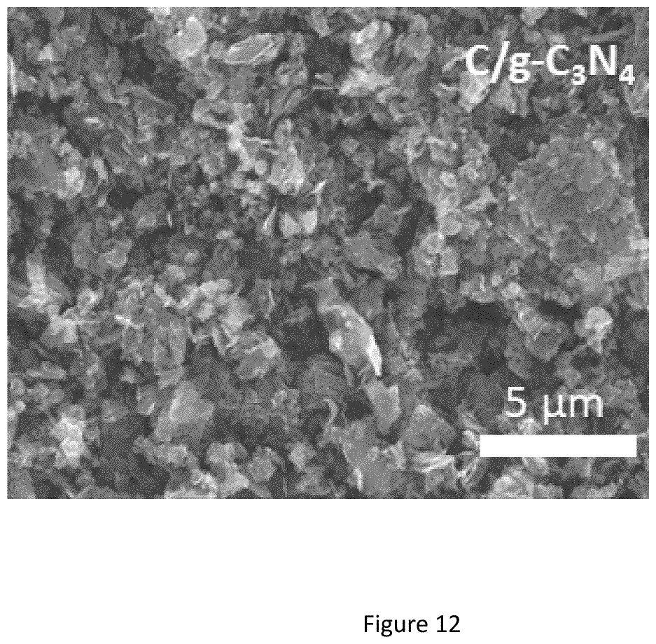

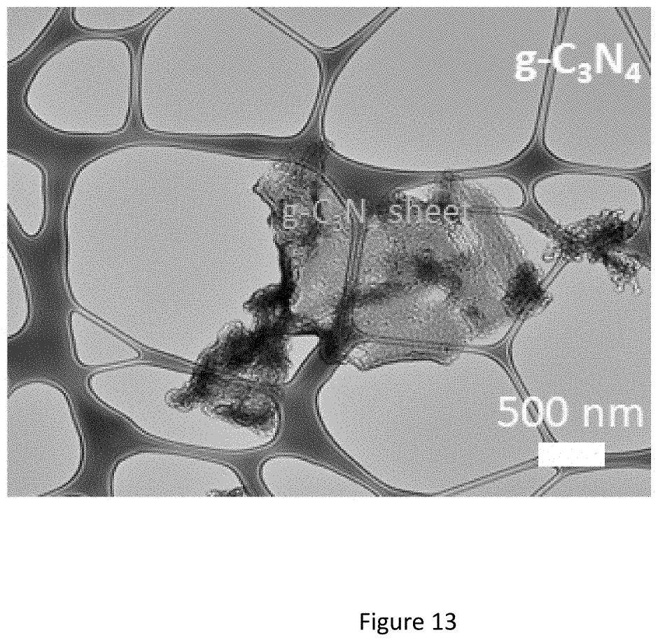

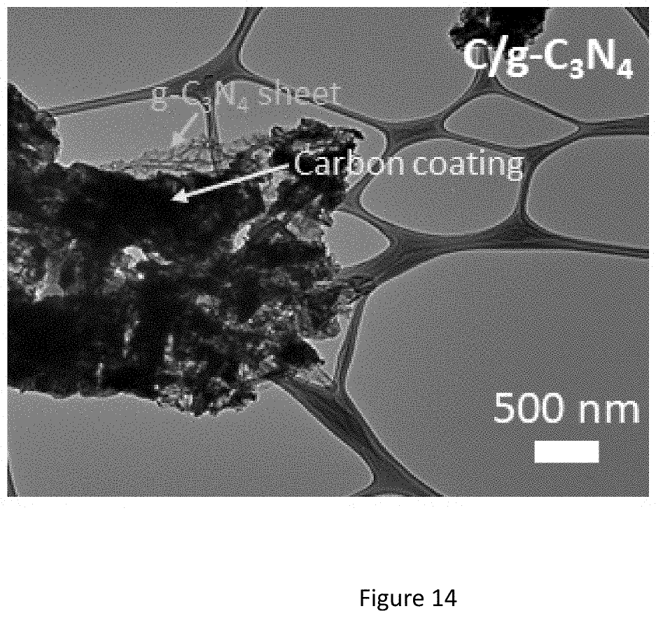

Scanning electron microscopy (SEM) and transmission electron microscopy (TEM) were used to characterize the morphology of the as-prepared materials. The SEM shows that a sheet-like structure of g-C₃N₄ is formed (FIG. 11). This finding further confirms the interlayer-stacking structure is destroyed (as discussed in the XRD section). Similarly, C/g-C₃N₄ also exhibits a noticeable sheet-like structure (FIG. 12). The microstructure interlayers were characterized using TEM in order to provide direct visible proof of the existence of carbon-layer-coated g-C₃N₄. An isolated piece of the as-prepared g-C₃N₄ displays a two-dimensional sheet-like structure with a lateral scale of several micrometers (FIG. 13 and FIG. 14). Interestingly, we observe a black carbon layer coating on an isolated piece of C/g-C₃N₄. The typical sheet-like structure of g-C₃N₄ can also be observed in the composite, indicating the development of polymeric planes of carbon nitride even with the presence of asphalt or as-formed aromatic carbon intermediates. The interaction between the carbon and g-C₃N₄ layers is strong, as 30 mins ultrasonication was used to prepare these TEM samples. In addition to improving the electronic conductivity, the carbon coating and/or interface between the interlayers can further introduce additional Na-storage (as confirmed by the latter section).

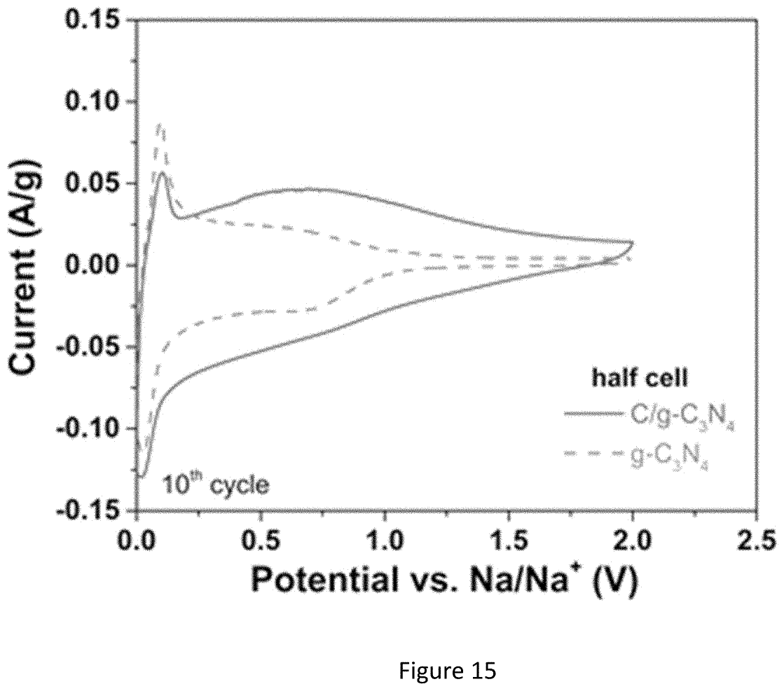

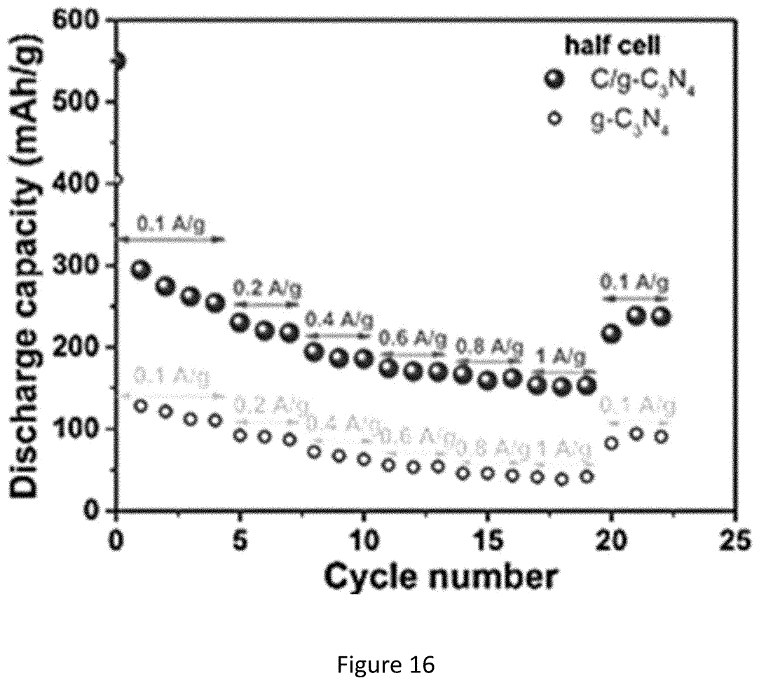

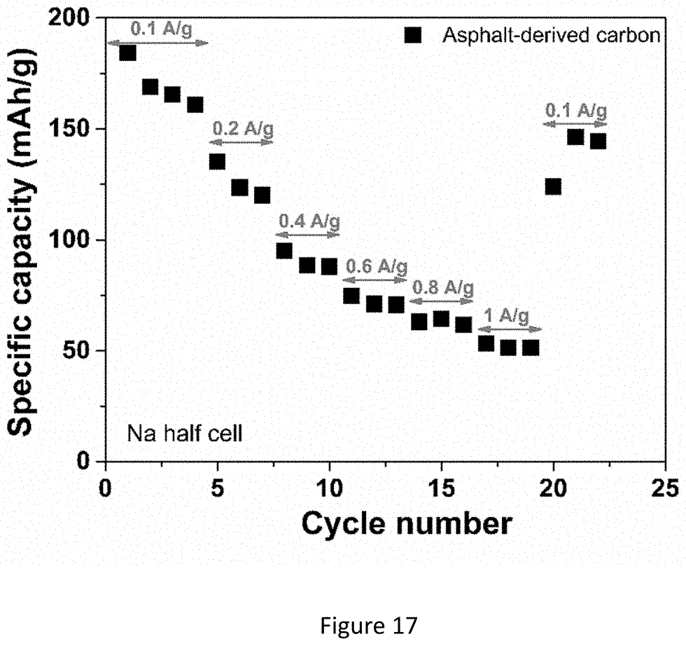

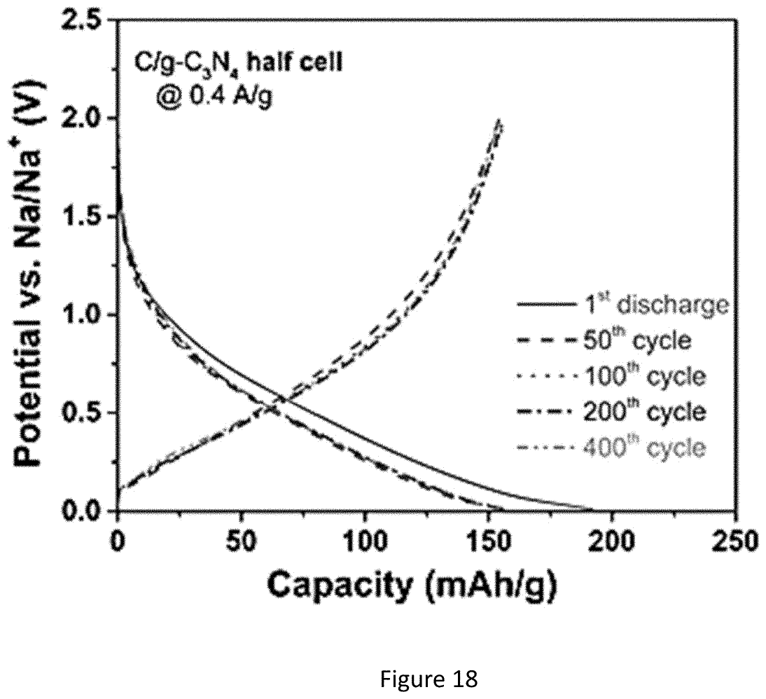

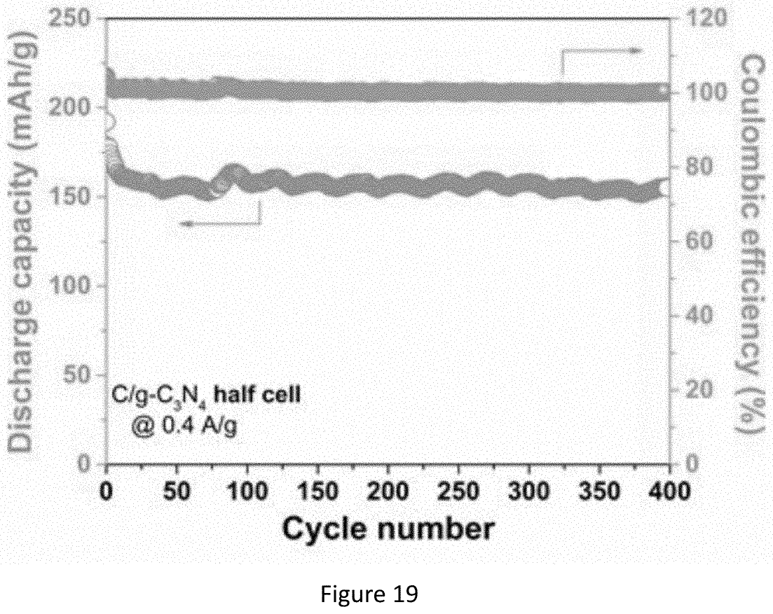

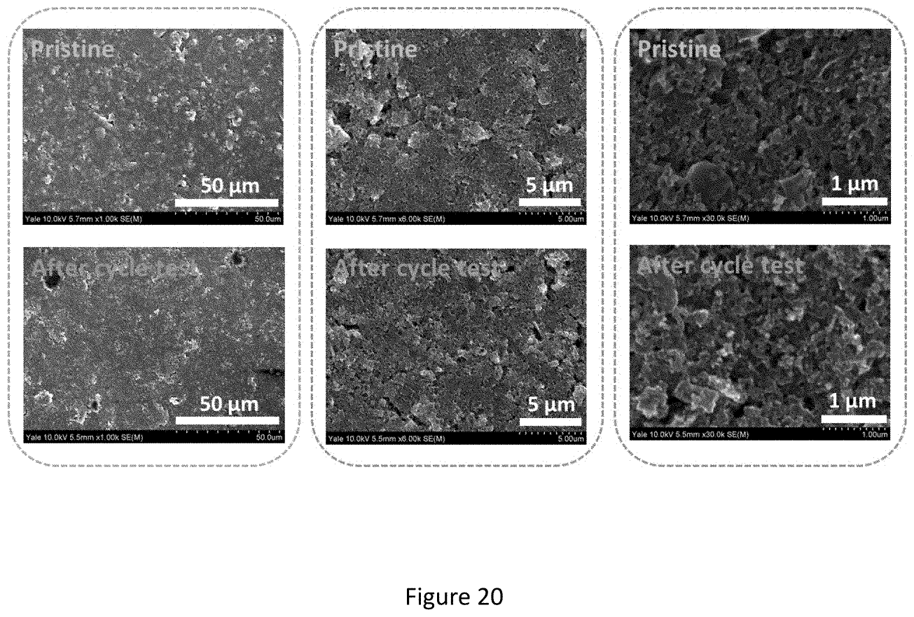

The electrochemical performance of the as-prepared C/g-C₃N₄ is first evaluated with a half cell device, in which Na metal is used as the counter electrode. Cyclic voltammetry (CV) was conducted in order to understand the Na storage mechanism; g-C₃N₄ is also included for comparison. In both cyclic voltammograms (FIG. 15), the reversible peaks at very low voltage values (vs Na/Na⁺), i.e., at about 0.02 V in reduction and about 0.1 V in oxidation, could be due to the intercalation/deintercalation of Na⁺ ions into the nanopores of the carbon materials (Komaba, et al., Adv. Funct. Mater. 2011, 21, 3859). However, most Na storage capacity of these electrode materials stems from the potential window between 1.2 and 0.3 V, which may be assigned to the Na⁺ insertion between the interlayers. Interestingly, C/g-C₃N₄ shows about 2 times higher Na storage capacity in the region between 1.2 and 0.3 V. This finding suggests that the carbon coating and/or interface between the interlayers lead to higher Na-storage. Note: all specific current densities and capacities are based on the total mass of the negative active materials. In line with the CV results, the C/g-C₃N₄ Na half cell demonstrates excellent C-rate performance. Specifically, the cell shows 254, 220, 186, 170, 159 and 151 mAh/g at 0.1, 0.2, 0.4, 0.6, 0.8 and 1 A/g, respectively (FIG. 16). In contrast, inferior rate performance is observed for the g-C₃N₄ Na half cell, indicating improved performance as a result of the carbon coating. The electrochemical performance of the asphalt-derived carbon (FIG. 17) suggests that the improved performance of C/g-C₃N₄ is mainly due to its unique interlayered structure. The C/g-C₃N₄ Na half cell was characterized using galvanostatic cycling at 0.4 A/g (FIG. 18 and FIG. 19). Reversible charge/discharge curves are observed, and an average capacity of about 160 mAh/g is shown over 400 cycles (FIG. 18). An extremely high Coulombic efficiency (CE, >99.9%) and negligible capacity fading are achieved for this Na half cell (FIG. 19). No significant morphological changes of the C/g-C₃N₄ electrode were observed via SEM before and after cycling (FIG. 20).

The average highest Na capacity of this system is about 150 mAh/g while 110 mAh/g for g-C₃N₄ (FIG. 16). Therefore, simply mixing these two materials can only deliver a capacity of about 130 mAh/g assuming no interaction occurs during physical mixing. But the proposed C/g-C₃N₄ can show a higher capacity of about 260 mAh/g. This means the significant improvement in Na-storage capacity by using C/g-C₃N₄ is due to its unique interlayered structure.

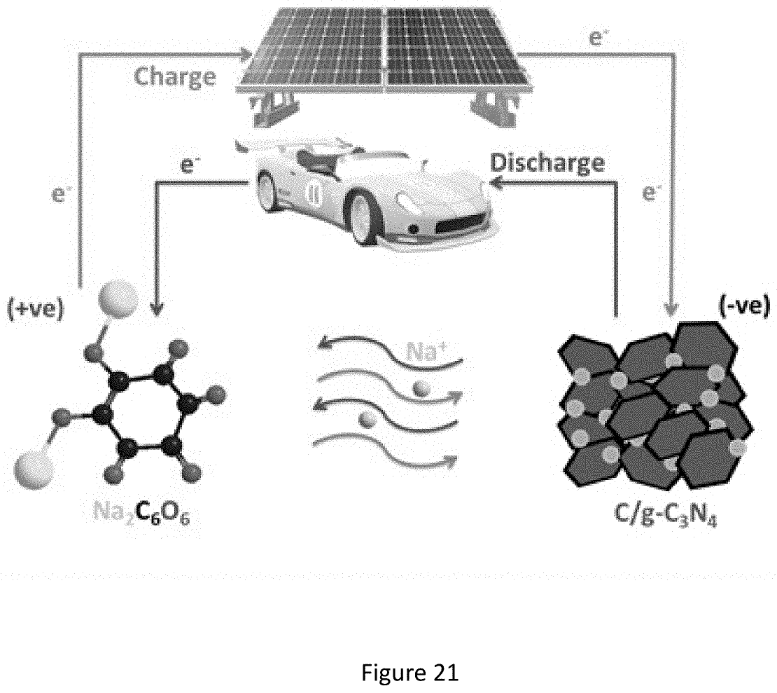

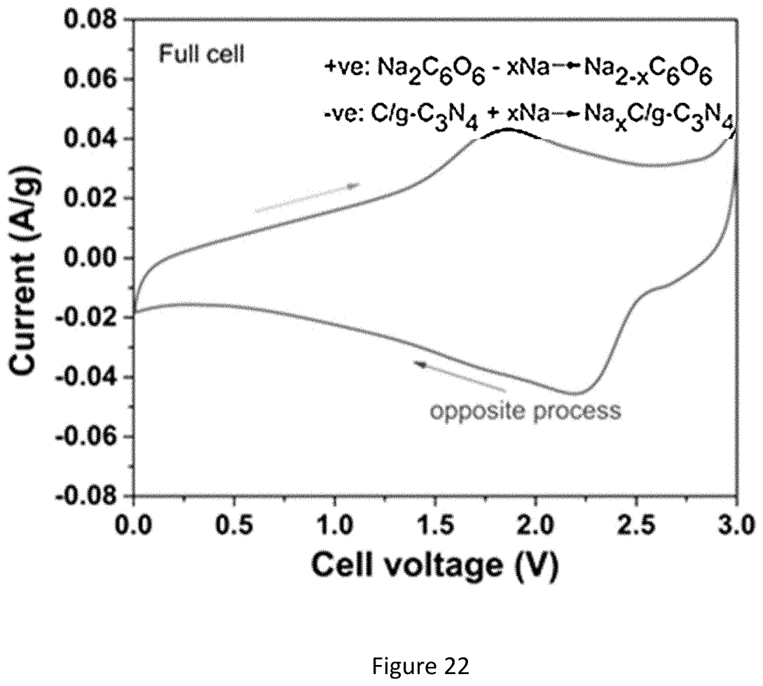

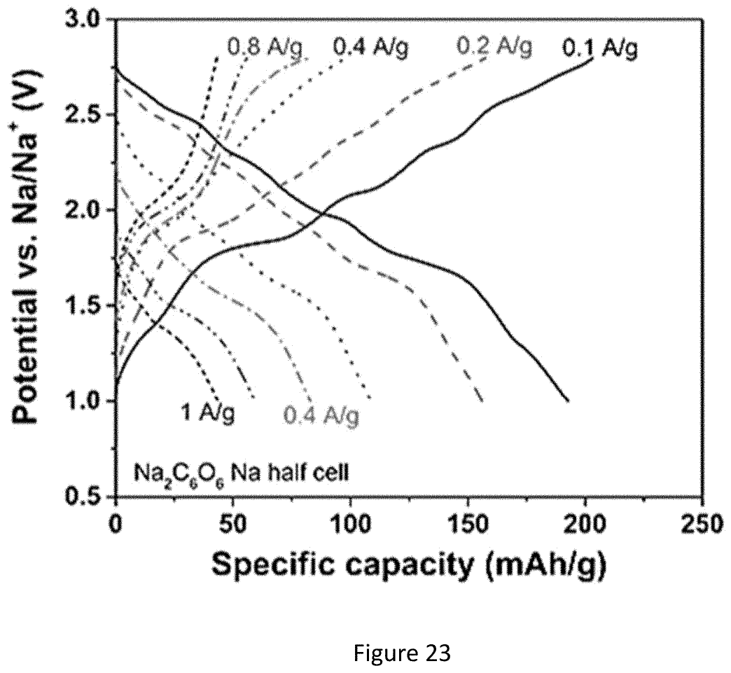

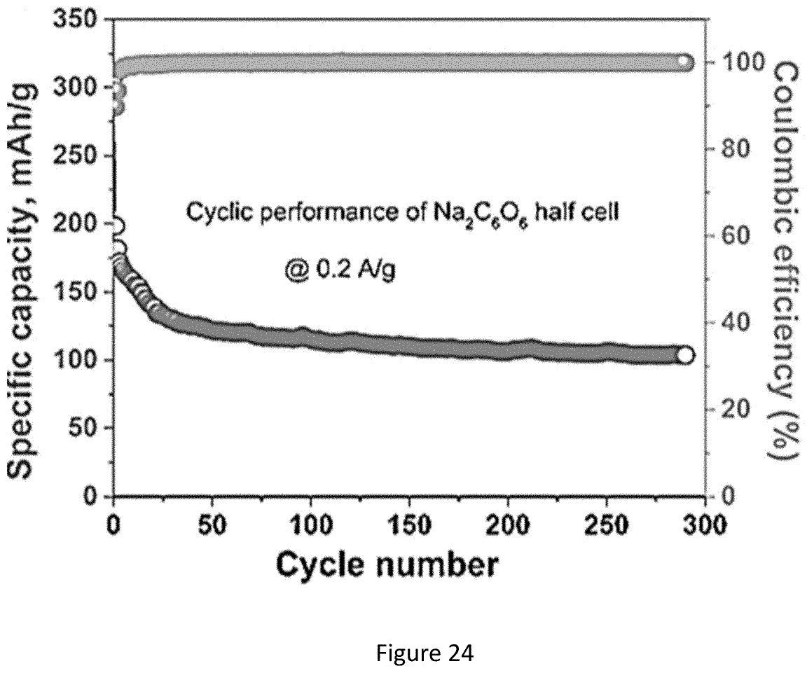

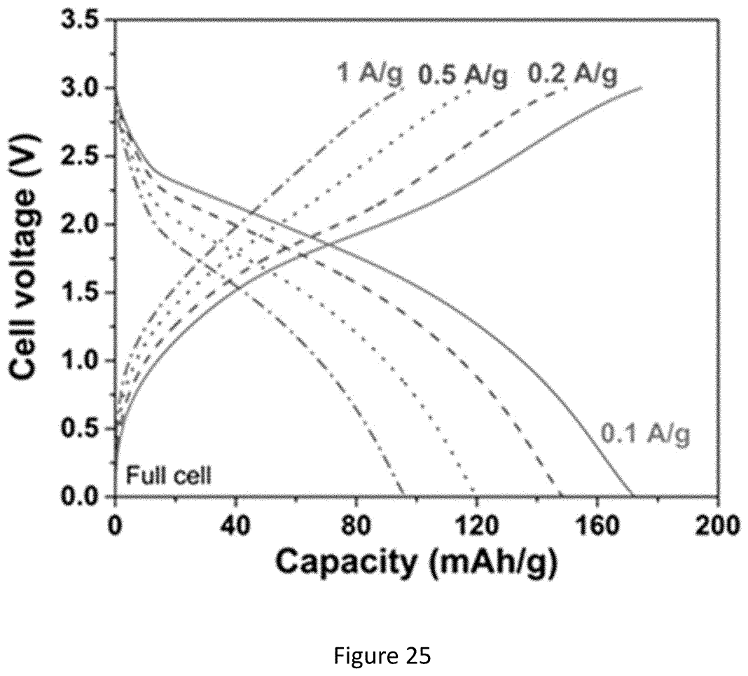

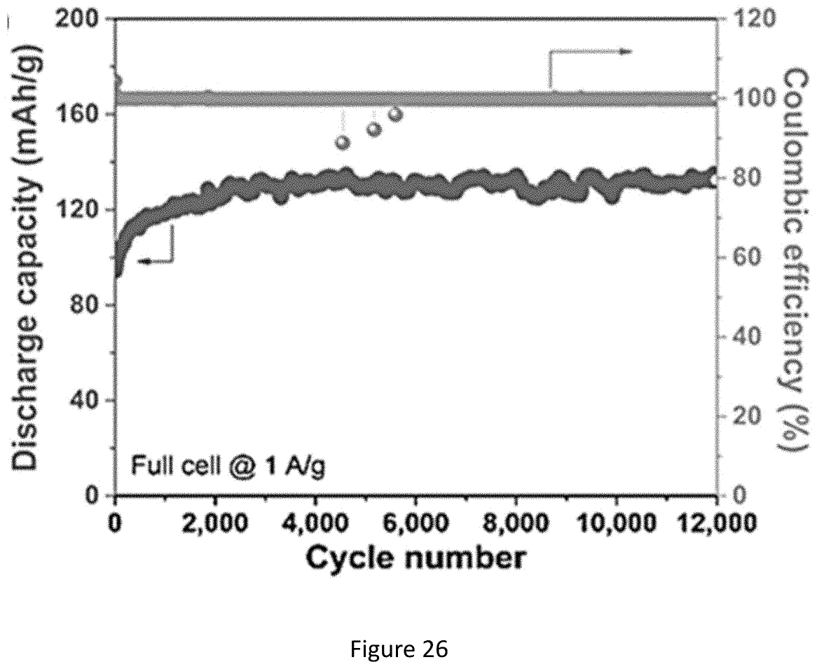

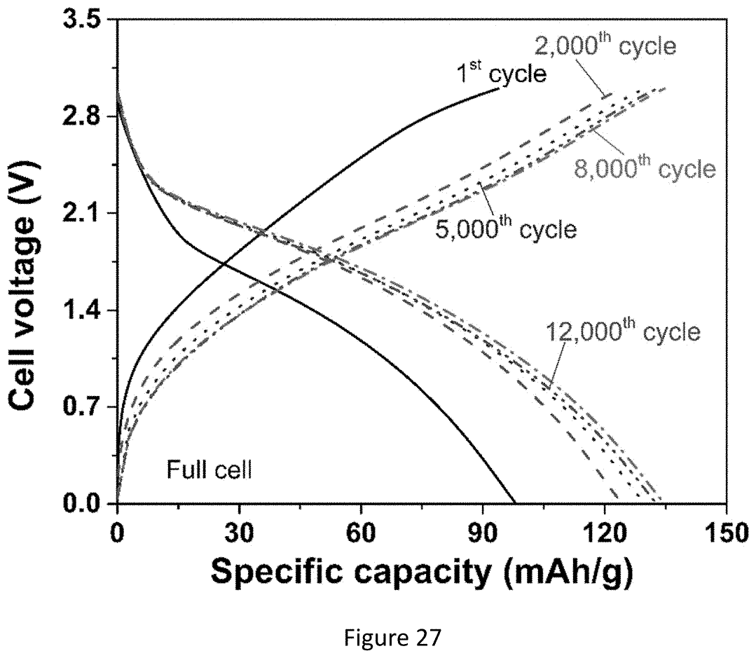

To provide a full picture of this as-prepared C/g-C₃N₄ negative electrode, it was evaluated in a full cell device (FIG. 21) in which sodium rhodizonate dibasic (Na₂C₆O₆), a promising organic positive electrode (Wang, et al., Nano Lett. 2016, 16, 3329; Lee, et al., Nat. Energy 2017, 2, 861), is used as the positive electrode. The characterization of the as-prepared Na₂C₆O₆ is shown in FIG. 3. The CV of this full cell displays one pair of well-defined redox peaks located at 1.2-2.5 V, which directly indicates the operating voltage for this type of Na full cell (FIG. 22). The response current increases rapidly during the forward scan in the region between 2.8 to 3 V and is due to the formation of Na_{x≤2}C₆O₆ with higher oxidation state (Lee, et al., Nat. Energy 2017, 2, 861). To avoid any irreversible side reactions, the full cell was operated with a cutoff voltage window between 0.01 to 3.0 V (FIG. 3, FIG. 23, and FIG. 24). As shown in FIG. 25, this C/g-C₃N₄ Na full cell delivers good C-rate performance. Specifically, the cell shows 172, 148, 120 and 96 mAh/g at 0.1, 0.2, 0.5 and 1 A/g, respectively (FIG. 25). High Coulombic efficiency (CE, ˜99.8%), an average energy efficiency (EE) of ˜75% was demonstrated, and the discharge capacity remains at ˜120 mAh/g after 12,000 cycles at 1 A/g (FIG. 26). Remarkably, this finding discloses a negligible capacity fading rate for this C/g-C₃N₄ Na full cell over a long-term operation period. Specific charge/discharge curves are shown in FIG. 27. A gradual increase of discharge capacity was observed upon cycling to 3000 cycles which subsequently stabilized at ˜120 mAh/g. This gradual increment in deliverable capacity could be ascribed to the activation of the electrode or/and system. Such long cycling performance is most likely ascribed to the superior structural stability of the electrode materials. The NIBs with C/g-C₃N₄ demonstrate a very high capacity among the g-C₃N₄ based negative electrode materials. In addition, they show an excellent cyclability among NIBs with carbon-based electrode materials. The NIB described herein represents an ultralong cycle-life NIB with low-cost and scalable materials. Further improvement in electrochemical performance could be achieved by the choices of electrolyte solvents, additives (e.g., fluoroethylene carbonate) and electrode preparation methods (e.g., roll-pressing).

In summary, low-cost carbon-coated graphitic carbon nitride (C/g-C₃N₄) nanosheets can be used as the negative electrode for a long-life sodium-ion battery. Compared to its counterpart, a Na storage capacity approximately twice as high was achieved for this system. C/g-C₃N₄ can be combined with Na₂C₆O₆ to create a full cell with high CE and a stable cycling (>12,000 cycles at 1 A/g). This design strategy offers effective strategies to develop low-cost and long-life NIBs.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

We claim:

1. A composition comprising a graphitic carbon nitride material and a conductive carbon material coating.

2. The composition of claim 1, wherein the graphitic carbon nitride material comprises graphitic carbon nitride.

3. The composition of claim 1, wherein the graphitic carbon nitride material is selected from the group consisting of a nanosheet, a nanoparticle, a nanowire, a nanorod, a quantum dot, and a 3D network.

4. The composition of claim 1, wherein the conductive carbon material comprises at least one allotrope of carbon selected from the group consisting of graphene, graphene oxide, reduced graphene oxide, graphenylene, graphite, exfoliated graphite, AA′-graphite, Schwarzites, graphite oxide, carbon fiber, activated carbon, carbon nanotubes, buckminsterfullerenes amorphous carbon, glassy carbon, carbon aerogels, carbon foam, and Q-carbon.

5. The composition of claim 1, wherein the conductive carbon material comprises amorphous carbon.

6. The composition of claim 1, wherein the conductive carbon material further comprises at an additional element selected from the group consisting of hydrogen, boron, nitrogen, oxygen, silicon, phosphorous, sulfur, germanium, arsenic and selenium.

7. The composition of claim 1, wherein the conductive carbon material further comprises an alkali metal, an alkaline metal, or a transition metal.

8. The composition of claim 1, wherein the graphitic carbon nitride material is partially coated with the conductive carbon material.

9. The composition of claim 1, wherein the graphitic carbon nitride material is fully coated with the conductive carbon material.

10. The composition of claim 1, wherein the composition comprises multiple graphitic carbon nitride layers with the conductive carbon material therebetween.

11. An electrode comprising the composition of claim 1 and a conductive metal.

12. A battery comprising the electrode of claim 11 and a positive electrode.

13. A sodium ion battery comprising the composition of claim 1 and a sodic positive electrode.

14. A method of making a composition comprising a graphitic carbon nitride material and a conductive carbon material coating; the method comprising the steps of:
providing a nitrogenous compound;
adding a carbonaceous material to the nitrogenous compound to form a slurry;
drying the slurry to form a coated mixture; and
carbonizing the coated mixture.

15. The method of claim 14, wherein the nitrogenous compound is selected from the group consisting of urea, thiourea, guanidine, cyanamide, dicyanamide, cyanuric acid, melamine, uric acid, and combinations or derivatives thereof.

16. The method of claim 14, wherein the carbonaceous material is selected from the group consisting of asphalt, natural bitumen, refined bitumen, recycled bitumen, polymer-modified bitumen, rubber, styrene-butadiene polymers, recycled tires, petroleum pitches obtained from a cracking process, coal tar, recycled crumb rubber, petroleum oil, oil residue of paving grade, plastic residue from coal tar distillation, petroleum pitch, asphalt cements, cutback asphalts, kerogen, asphaltenes, petroleum jelly, and paraffins.

17. The method of claim 14, wherein the step of drying the slurry further comprises the step of grinding the slurry.

18. The method of claim 14, wherein at least one of the nitrogenous compound and the carbonaceous material further comprises a solvent.

19. The method of claim 18, wherein the solvent is selected from the group consisting of methanol, ethanol, 1-pronanol, 2-propanol, n-butanol, 1-pentanol, t-butyl alcohol, carbon tetrachloride, chlorobenzene, ethyl acetate, acetone, dichloromethane, chloroform, benzene, toluene, ethylene glycol, pentane, hexane, petroleum ether, diethyl ether, acetic acid, acetonitrile, 1,2-dimethoxyethane, dimethylformamide, dimethyl sulfoxide, 1,4-dioxane, n-methyl-2-pyrrolidinone, nitromethane, pyridine, tetrahydrofuran, triethylamine, xylenes, or a combination thereof.

20. The method of claim 14, wherein the step of carbonizing the coated mixture comprises the step of heating the coated mixture to a temperature of at least 500° C. in an inert atmosphere.
